(19) United States
(12) Patent Application Publication
(10) Pub. No.: US 2025/0265143 A1
(43) Pub. Date: Aug. 21, 2025

(54) DEFECT DETECTION BASED ON ACOUSTIC SIGNALS

(71) Applicant: Intel Corporation, Santa Clara, CA (US)

(72) Inventors: Héctor Alfonso CORDOURIER MARURI, Guadalajara (MX); Prabhakar SUBRAHMANYAM, San Jose, CA (US); Diego Mauricio CORTES HERNANDEZ, Beaverton, OR (US); Sandra Elizabeth COELLO CHAVARIN, Zapopan (MX); Rosa Jacqueline SANCHEZ MESA, Zapopan (MX); Jesus Rodrigo FERRER ROMERO, Zapopan (MX); Margarita JAUREGUI FRANCO, Zapopan (MX); Alvaro ESCOTO RAMIREZ, Zapopan (MX); Dario N. OLIVER, Hillsboro, OR (US); Carlos CARRIZO, Portland, OR (US); Marcos E. CARRANZA, Portland, OR (US); Mateo GUZMAN, Beaverton, OR (US); Cesar Ignacio MARTINEZ SPESSOT, Hillsboro, OR (US)

(21) Appl. No.: 18/581,264

(22) Filed: Feb. 19, 2024

(51) Int. Cl. G06F 11/07; G01M 99/00

(52) U.S. Cl. CPC G06F 11/0793; G01M 99/002; G01M 99/005; G06F 11/0709; G06F 11/0754

(57) ABSTRACT

Examples described herein relate to circuitry to receive data associated with a device and indicate whether the device is potentially malfunctioning based on anomalous sounds in an operational server and based on an activity indicator of the server. In some examples, the device includes one or more of: a processor, a memory device, a thermal manager device, or a circuit board. In some examples, the data comprises a temperature signal and a sound signal and the circuitry is to: based on a first level of the temperature signal and a first characteristic of the sound signal, determine that the device of the server is potentially malfunctioning and based on a second level of the temperature signal and a second characteristic of the sound signal, determine that the device of the server is not potentially malfunctioning.

### BACKGROUND

Some server computers are installed in locations where access to components of the server may be restricted from physical inspection or testing, making it difficult to detect faults in the server without taking the server offline or interrupting operation of the server. Some server failures can occur over time due to aging, thermal stress, or wear of the components or the printed circuit board (PCB). Detecting time-dependent failures while a server is operating typically involves continuous monitoring or periodic inspections by a technician. The available information on servers may be limited to system-level symptoms, making it difficult to isolate and identify the root cause of server failure.

### BRIEF DESCRIPTION OF THE DRAWINGS

FIG. 1 shows an example system.

FIG. 2 shows an example classification of sound patterns by type of fault and sound baseline.

FIG. 3 depicts an example operation to identify a potentially failing device.

FIG. 4 depicts an example of placements of acoustic sensors.

FIG. 5 depicts an example of audio capture.

FIG. 6 depicts an example of spectrum of recorded audio signals.

FIG. 7 depicts an example of training and inference stages of detection of a potentially malfunctioning device using multiple ML models

FIG. 8 depicts an example of noise controlled environments.

FIG. 9 depicts an example process.

FIG. 10 depicts an example system.

### DETAILED DESCRIPTION

Prior to deployment or customer use of a PCB, testing procedures can be used to detect defects in the PCB, such as in-circuit testing (ICT), Automated Optical Inspection (AOI), performance testing with respect to specifications (e.g., Peripheral Component Interconnect Express (PCIe), Serial AT Attachment (SATA), Serial Peripheral Interface (SPI), or others), or X-ray inspection, to identify defective components connected to the PCB and prevent its deployment or perform corrective actions. After the PCB is deployed inside a chassis by a customer, temperature and elements can change over time and components connected to the PCB or the PCB itself can malfunction.

Before or after deployment of a server, various examples can perform testing of the server (e.g., components, devices, chassis (e.g., housing), circuit boards, and others) based on detected acoustic data to identify defects or actual or potential malfunction by detecting changes in acoustic data associated with the server. After assembly of the server, a reference acoustic data of the server could be captured and characterized. During assembly and after fabrication and deployment of the server, performance checks can be performed in-situ and with the server turned-on and operating to identify faults in the server based on changes in acoustic data relative to the reference acoustic data. In some examples, defective air fans or fluid impellers in the server can be identified as well as location of defective fans or impellers can be determined. Inspection of the server by acoustic data testing can identify defects of the server where the characteristic of defect depends on changes in the acoustic data relative to the reference acoustic data. The detected acoustic data can be correlated with the nature of the defect to identify a defective component and location of defective component using a trained machine learning (ML) system. Specific device failure or server failure can be detected and predicted. The system can notify a technician to perform a repair or replacement of a potentially malfunctioning device.

Various examples utilize microphone(s) with temperature sensors and vibration sensors attached to a manageability component (e.g., baseboard management controller (BMC), Intel® Management or Manageability Engine (ME), or other devices). Microphone(s) can capture acoustic data that can be used to enable early detection of mechanical failures based on a noise delta compared to equipment working as per specification (e.g., reference sound pattern). Manageability components can perform analysis of information of a health monitoring platform to identify a sound anomaly, determine the cause of the issue, and trigger an alert so that further analysis can be performed.

Acoustic sensors can be deployed in a noise-controlled environment because external environment noises can negatively affect the accuracy of artificial intelligence (AI) or ML models and/or generate false positives of sound anomalies. A noise-controlled environment can be implemented by using a noise isolated enclosure or including active noise filters to reduce contextual interferences.

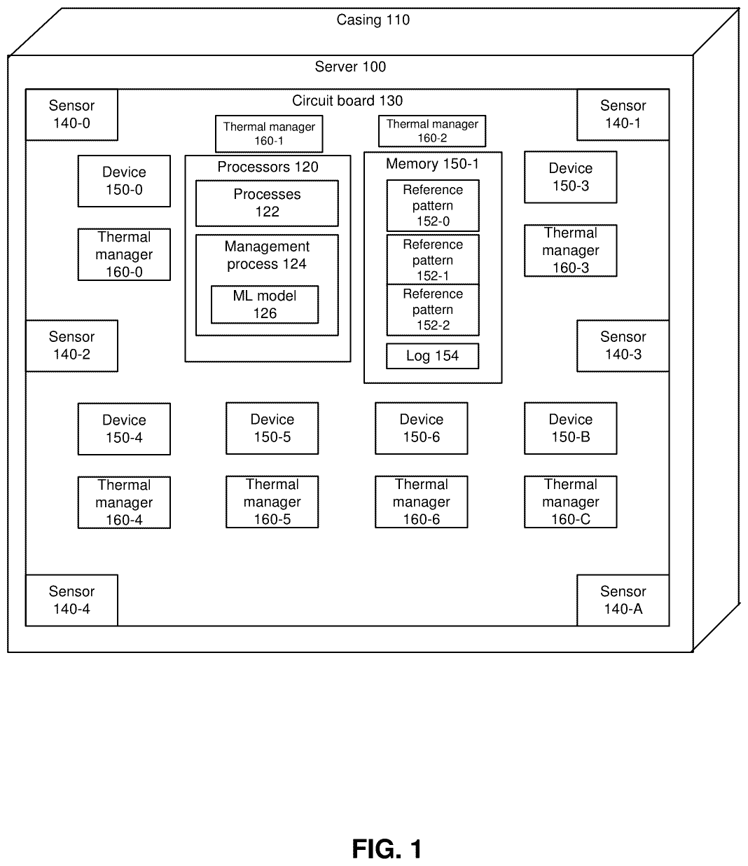

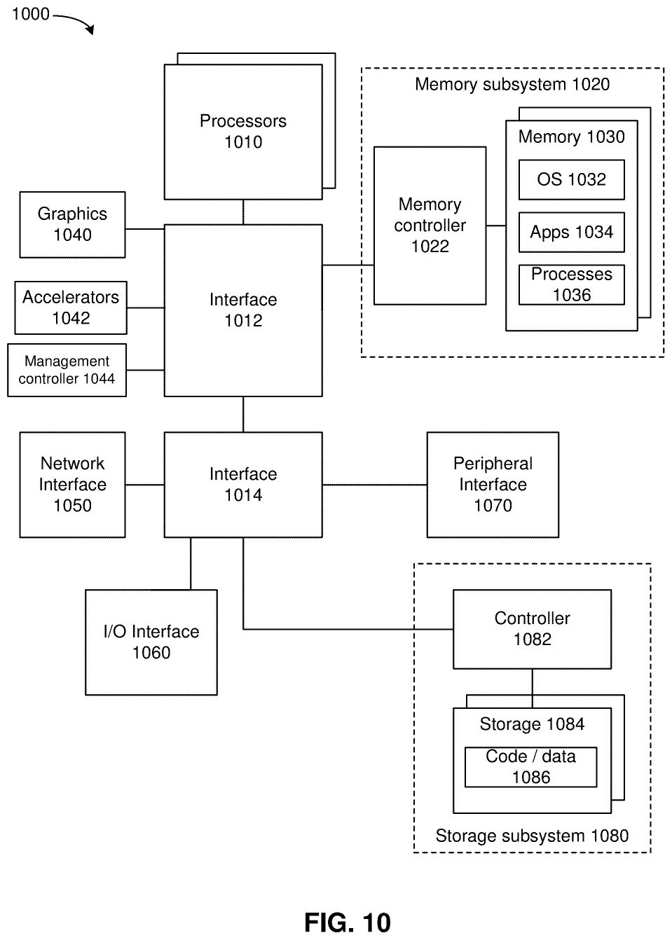

FIG. 1 depicts an example system. Server system 100 can include components described herein within casing 110. In some examples, a server includes a network interface device with a processor, direct memory access (DMA) circuitry, memory device, and a network interface. Example circuitry, firmware, and software of server 100 are described at least with respect to FIG. 10. Casing 110 can provide a noise controlled environment for server 100. For example, casing 110 (e.g., chassis) can provide a noise isolated or reducing metal enclosure or enclosure with active noise filters or noise reducers. Various examples of casing 110 are described herein.

Devices 150-0 to 150-B, where B is an integer, can include components such as memory (e.g., dual inline memory modules (DIMMs), accelerators, application specific integrated circuits (ASICs), graphics processing units (GPUs), central processing units (CPUs), field programmable gate arrays (FPGAs), network interface devices, etc. Thermal management devices 160-0 to 160-C, where C is an integer, can include air cooling fans or impellers to force air or liquid to flow over devices to remove heat from such devices or add heat to such devices. Air cooled systems can utilize heat sinks (not shown) to dissipate heat away from devices 150-0 to 150-B.

Circuit board 130 can utilize connector traces that can provide connectivity among at least processors 120, acoustic sensors 140-0 to 140-A (where A is an integer), devices 150-0 to 150-B, and thermal management devices 160-0 to 160-C. Acoustic sensors 140-0 to 140-A can capture or record acoustic signals or sounds, as described herein. Acoustic sensors 140-0 to 140-A can be deployed in a noise-controlled environment to reduce environment noises external to casing 110 that can negatively affect the accuracy of machine learning (ML) models and/or generate false positive identification of sound anomalies.

In some examples, server 100 can utilize impellers as thermal management devices to force liquid to dissipate heat away from devices 150-0 to 150-B. Example liquids include variants of 3M™ Novec™ or Fluorinert™ (e.g., FC-72), which can have boiling points around 59 degrees Celsius. For example, liquid can be clear, colorless, non-conductive, non-flammable, residue free, thermally and chemically stable liquid. Liquids can be non-ionic and so do not transfer electricity, and are of a medium viscosity in order to facilitate effective natural convection.

For example, two phase immersion liquid cooling (2PILC) (or 2PIC) can be used such that a high density compute column (with potentially no heatsinks), is immersed into a liquid that has a low boiling point. These liquids can be organic compounds that are non-conductive and non-corrosive and that directly contact silicon devices. 2PILC can be used such that a server (with potentially no heatsinks) can be immersed into a liquid that has a relatively low boiling point. Liquids can be organic or inorganic compounds that give direct contact to silicon-based circuitry and as the silicon is used it will give off heat which is transferred into the liquid around it, causing the liquid to boil. Boiling turns the liquid into a gas and the gas rises, forcing convection of the liquid. The liquid then condenses on a cold plate or water pipe and falls back into the tank as liquid for re-use. Examples are not limited thereto. Some examples use extra forced convection which helps with liquid transport and supports higher thermal design points (TDPs). Some examples use single phase immersion cooling or air cooling.

Processors 120 can execute at least management process 122 and process 124. Management process 124 can include an operating system (OS), device driver, or other user or kernel space process. Management process 124 can generate baseline or reference acoustic pattern of server 100 by recording an acoustic pattern measured for different load levels on one or more of devices 150-0 to 150-B. An acoustic pattern can include a signal that measures amplitude and frequency of acoustic signals generated during a time span. Active cooling of server 100 can utilize heat sinks with thermal management devices 160-0 to 160-C (e.g., fans or impellers) so that fans blow air over some components without a component fan (passive cooling) mounted on them. Fans can emit a specific noise based on revolutions per minute (RPM) of fan blades. The sound pattern (e.g., pitch), acoustic levels that vary with the operating RPM, amplitude (dB), and the frequency for fans installed can be measured and characterized when or before server 100 is deployed with a customer and periodically thereafter to determine new reference sound patterns. A sound pattern or acoustic data can include a signal that measures amplitude and frequency of acoustic signals generated during a time span. Moreover, reference vibration data can be captured when or before server 100 is deployed with a customer and periodically thereafter to determine new reference vibration data.

For example, a reference pattern 152-0 can represent a reference sound pattern, vibration data, and/or temperature during no load on devices 150-0 to 150-B at time 0. For example, at time 1, a later time than time 0, a reference pattern 152-1 can represent a reference sound pattern and/or temperature during no load on devices 150-0 to 150-B. For example, at time 2, a later time than time 1, a reference pattern 152-2 can represent a reference sound pattern and/or temperature during no load on devices 150-0 to 150-B. Additional reference patterns can be stored. Reference patterns can be overwritten or deleted.

Management process 124 can detect failures in components and thermal management devices in server 100 by measuring sound characteristics and vibration data and deviation from measured sound characteristics against reference acoustic patterns and vibration data. The characteristic of the defect can depend on the acoustic pattern, as described herein. In some examples, management process 124 can correlate detected sounds and vibrations with the nature of the defect using trained machine learning (ML) and inference model 126.

Processors 120 can train ML model 126 with acoustic data and/or vibration data for scenarios where a group of one or more of devices 150-0 to 150-B or one or more of thermal management devices 160-0 to 160-C are malfunctioning so that ML model can identify potentially malfunctioning thermal management device based on the acoustic data and/or vibration data. Processors 120 can re-train ML model 126 after server 100 is deployed and then perform periodic re-training to adjust to changes in the environment outside of the casing 110. Processors 120 can execute inferencing aspect of ML model 126 to search for different acoustic patterns and/or vibration data from internal and external environment inputs, while considering data indicative of load on server 100 from operation (e.g., activity logs, event data). Sounds internal to casing 110 may not be limited to noise generated by mechanical components, but also can include sound patterns and/or vibration data generated or modified by non-mechanical components. In some examples, loose memory module not properly seated may generate a higher level of vibrations than a reference level of vibrations). In addition, a malfunctioning fan can exhibit a higher level of vibrations than a reference level of vibrations.

A mechanical component can include a device with moving parts such as a spinning hard disk drive, a fan, or impeller. A non-mechanical device can include a device with no moving parts such as a processor, memory, storage, input/output (I/O) device, or others. A non-mechanical device failure or failure of an aspect of a non-mechanical device can include loosening of connectivity to a circuit board or loosening of bond of the device to a circuit board.

Event log 154 can indicate a level of operational activity of server 100, including activity of processors (e.g., operations per second), activity level of memory (e.g., memory reads or writes per second), activity level of storage (e.g., storage reads or writes per second), activity level of input/output devices (e.g., transmit or receive rates of network interface devices or buses). Specific system logs 154 stored in memory 150-1 can indicate whether the system is booting, and so that specific beeping from the motherboard's piezo buzzer can be expected, and ML model 126 can determine such sounds are not indicative of a malfunctioning device. Event logs 154 can indicate heavy database (DB) query using a hard disk drive (HDD) with spinning storage medium generating clicking/humming noise and ML model 126 can determine such sounds are not an issue.

In some examples, management process 124 can be performed by a management controller (not depicted). A management controller can perform management and monitoring capabilities for system administrators to monitor operation at least of circuitry and software in server 100 using channels, including channels that can communicate data (e.g., in-band channels) and out-of-band channels. Out-of-band channels can include packet flows or transmission media that communicate metadata and telemetry and may not communicate data.

In some examples, ML model 126 can detect defects in installation, soldering, or gluing of components that can cause alteration of the transmission properties of server 100 and cause a change in a sound pattern. ML model 126 can perform analysis of sound and acoustic information and/or vibration data to identify a sound or acoustic and/or vibration data anomaly, determine the cause of the issue, and trigger the alert so further analysis can be performed.

In some examples, ML model 126 can detect anomalies based on sound and/or vibration data such as whether components (e.g., memory DIMMs, extension boards, connectors) have moved or dislodged on a server board without a local inspection by a person or robot.

In some examples, processors 120 can execute ML model 126 as multiple alternative ML models and then compare results for increasing result reliability of inference operations. For example, a Local Outlier Factor and Autoencoder learning technologies can be used, as described herein, to identify an anomaly sound or acoustic pattern and/or vibration data and reduce false positives.

For example, a base model of ML model 126 can be generated by the server manufacturer and distributed with the server. Once the server is deployed, ML models 126 can be re-trained with acoustic information and/or vibration data from the operative environment to increase the accuracy of detecting anomalous acoustic and/or vibration data scenarios (e.g., reduce false positives).

Some of the fans or impellers can operate using a Pulse Width Modulation (PWM) controller. The PWM control for the fans can indicate the Tj (junction temperature) from the processors or other heat emitting devices (e.g., one or more of devices 150-0 to 150-B). When the Tj increases, the RPM of the fans increase, and when the Tj decreases, RPM of the fan decreases by using the pulse width modulation (PWM) procedure/control of the fan to lower the acoustics. In some examples, RPM, Cubic Feet Per Minute (CFM) (airflow), and acoustics for different operating speed of the fans can be determined so that fan characteristics for different operating RPM of the fan speed can be determined by a mathematical interpolation. Note that reference to fans can refer to impellers or other thermal management devices and reference to impellers can refer to fans or other cooling devices.

Note that thermal management devices 160-0 to 160-C can provide cooling or heating of devices 150-0 to 150-B. For example, where server 100 is situated in an environment that is subject to cold temperatures, thermal management devices 160-0 to 160-C can heat devices 150-0 to 150-B to provide a suitable operating temperature for devices 150-0 to 150-B.

To identify a defective fan, management process 124 can perform: based on a level of the temperature signal being above a first level and a characteristic of the sound signal being above a first level, a fan can be determined to be malfunctioning and based on a level of the temperature signal being at or below a second level and a characteristic of the sound signal being at or below a second level, a fan can be determined to not be malfunctioning. A characteristic of the sound signal can include a level of one or more of: amplitude (e.g., dB), average amplitude level over a time duration, mean amplitude level over a time duration, median amplitude level over a time duration, or others.

Example pseudocode for detecting component fan defects:

```
IF A_{s,current} < (A_{s,stored}) // check if current fan speed is lower
    If T_{j,current} < T_{j,ref} // check if current Tj dropped
        // Fan speed dropped due to lower device temperature.
      If T_{j,ref} > T_{j,current} // Fan failed. Lower the CPU/GPU power or
      shutoff CPU/GPU power to prevent thermal runaway/device failure.
      Mail maintenance engineer failed device ID, chassis grid location.
      End if
  End if
End IF
```

A cluster of sensors 140-0 to 140-A can pinpoint the location of fan noise levels by spatial audio 360° orientations processed by management process 124. For system fans, the lower noise is flagged compared to the normal operating specifications of the sensor (fan) and management process 124 can determine a location of the failing/failed sensor.

Management process 124 can detect failures in thousands of racks with multiple servers in a rack and hundreds of thousands of fans and simulate hundreds of faulty fans for output. While examples are described with respect to fans, examples described herein can apply to power supply units (PSUs), HDDs, mechanical parts, and non-mechanical parts. Numerical values are merely exemplary.

Technologies described herein can apply to one or more data centers with 1000 racks, 10,000 servers and 100,000 fans. The following provides an example of identification of devices and fans in a 1000 rack implementation in a data center, a rack containing 10 servers, arranged vertically with a server ID of 1 to 10 from bottom to top with adequate 3U spacing between them, resulting in a total of 10,000 servers in the entire data center (DC). To provide cooling or heating of a CPU and GPU, a component thermal manager can be mounted directly on top of the respective CPU or GPU. For example, a server can utilize 4 CPU fans and 2 GPU fans, although other numbers of CPUs, GPUs, and fans can be utilized.

A rack can be identified by its unique grid location represented by its (X, Y) coordinates. To identify a specific CPU fan within a server housed in a particular rack of the datacenter, the notation (X, Y, server_id, CPU_id) is used such as (X, Y, 5, CPU_3), indicates the third CPU fan in the fifth server in the grid location (X, Y). To identify a specific GPU fan within a server housed in a particular rack of the datacenter, the notation (X, Y, server_id, GPU_id) is used such as (X, Y, 5, GPU_2), indicates the second GPU fan in the fifth server in the grid location (X, Y).

An example of fan telemetry data and status is as follows.

| | Tj | | A_s | A_s | |
|---|---|---|---|---|---|
| | current | Tj | current | stored | |
| Fan identifier | (° C.) | reference(° C.) | (dBA) | (dBA) | Status |
| CPU_Fan1 | 51.1 | 51.12 | 48.47 | 45.0 | Fan operation is normal as |
| | | | | | current fan acoustic data is |
| | | | | | higher or equal to reference |
| | | | | | acoustic data |
| CPU_Fan2 | 59.34 | 57.84 | 43.59 | 45.0 | Fan failure detected. Lower |
| | | | | | CPU power or frequency or |
| | | | | | shutdown CPU to prevent |
| | | | | | thermal runaway. |
| CPU_Fan3 | 51.87 | 52.92 | 44.03 | 45.0 | PWM control lowered fan |
| | | | | | speed to reduce noise. |
| | | | | | Monitor fan operation to |
| | | | | | identify anomaly. |
| | | | | | Potentially monitor |
| | | | | | vibration, acoustic, and |
| | | | | | temperature data for this fan |
| | | | | | more frequently than other |
| | | | | | fans. |
| GPU_Fan1 | 59.34 | 57.84 | 43.59 | 45.0 | Fan failure detected. Lower |
| | | | | | GPU power or frequency or |
| | | | | | shutdown GPU to prevent |
| | | | | | thermal runaway. |
| System_Fan1 | N/A | N/A | 37.60 | 45.0 | Fan failure detected. Fan |
| | | | | | speed is lower than |
| | | | | | reference fan speed. |

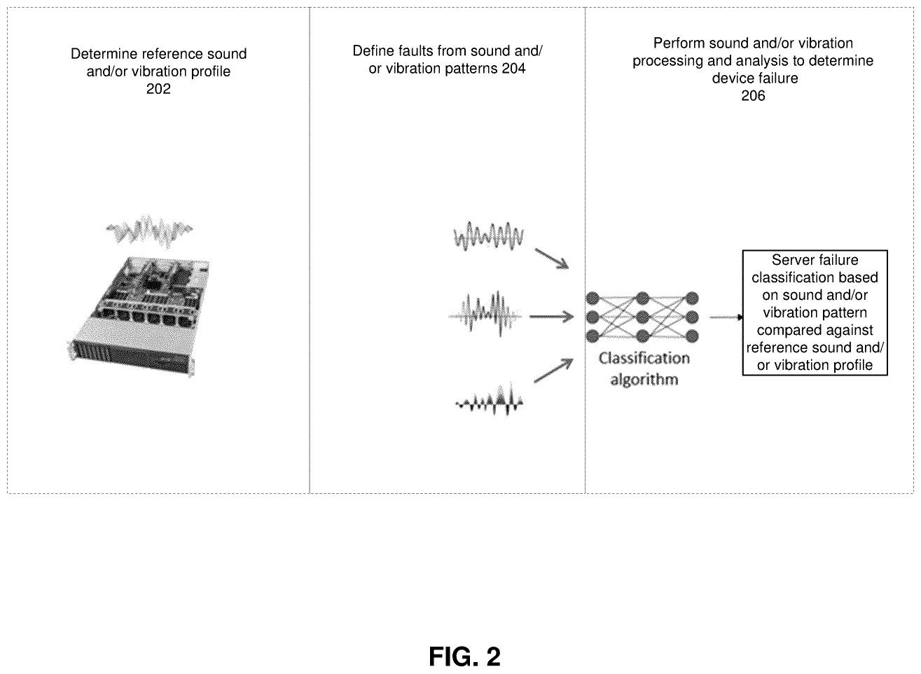

FIG. 2 shows an example classification of sound patterns by type of fault and sound baseline. Sound (mechanical waves) produced inside and outside of a server can provide information on the state of the system and identify possible or existing failures through the sound spectrum. These sound patterns depend on the thermal, mechanical, electrical, and vibrational response in the server.

At 202, a reference sound and/or vibration profile can be measured by microphones, acoustic sensors, or vibration sensors that can provide a baseline sound and/or vibration pattern for a correctly operating server. Microphones, acoustic sensors, and/or vibration sensors can be placed within and outside a server to capture sound emissions and/or vibration data. During the initial testing phase, the sound and/or vibration data emitted by the server under normal operating conditions can be recorded and serve as a reference sound and/or vibration profile. The recording captures a range of frequencies and characteristics of sound and/or vibration emissions from the PCB assembly. Background noise, as other acoustic sources can mask or interfere with the detection of sounds related to specific failures, can be identified in the reference sound profile.

At 204, a sound and/or vibration footprint definition in the sound spectrum and/or vibration data can be associated with a fault. Sound and/or vibration characteristics can be recorded where the server exhibits different failure modes (e.g., failure of HDD, failure of fan, failure of impeller, failure of memory device, and so forth). Specific sound and/or vibration data patterns can be associated with possible failures are identified, such as clicks, buzzes, or high-pitched noises. Sound and/or vibration data analysis results can be correlated with other diagnostics, such as visual inspection or electrical testing to validate the sound-based analysis indicates a defective state.

At 206, at least one ML can be applied for a correct classification of a fault. Sound and/or vibration data emitted by the server can be recorded during operation. Through sound and/or vibration patterns corresponding to the identified faults, at least one ML can be trained to process and interpret the recorded sound and/or vibration data to identify deviations from the reference sound profile and detect potential glitch-related sounds and/or vibration data that correspond to defective components or devices in a server. Based on reference sound and fault sounds and/or vibration data, for a detected sound and/or vibration deviation, corrective actions can be taken to address identified failures or potential problems.

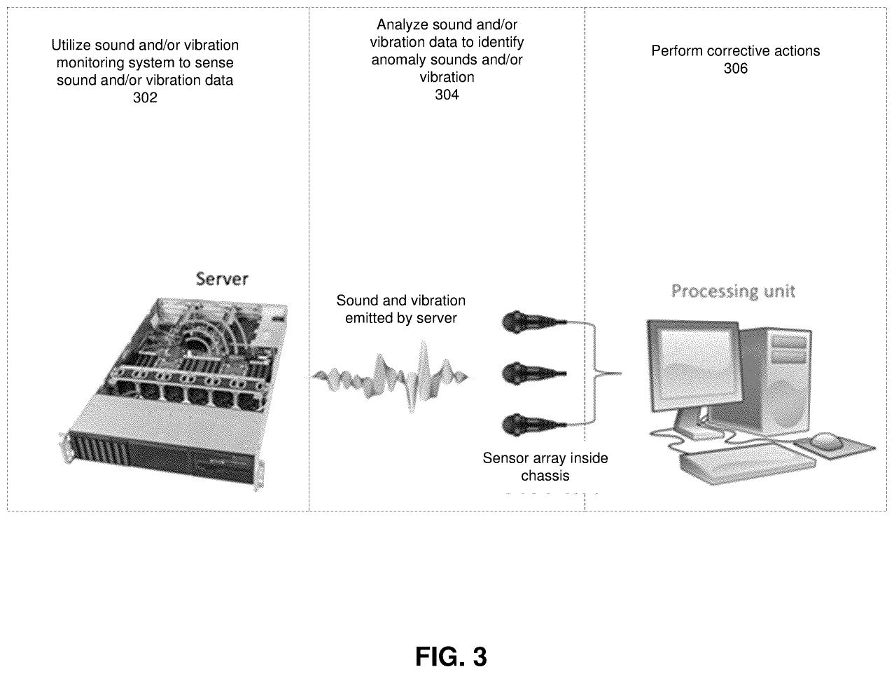

FIG. 3 depicts an example operation to identify a faulty device. At 302, sound and/or vibration data in the server can be captured by multiple microphones. At 304, the recorded sound and/or vibration data can be used for analysis and comparison with failure sound and/or vibration patterns. Deviations or anomalies in the sound and/or vibration patterns that may indicate possible device failures. At 306, corrective actions can be performed based on detected sound and/or vibration anomalies. For example, a microcontroller can reduce the power of device proximate or associated with a fan identified to be failing to prevent thermal runaway and device failure.

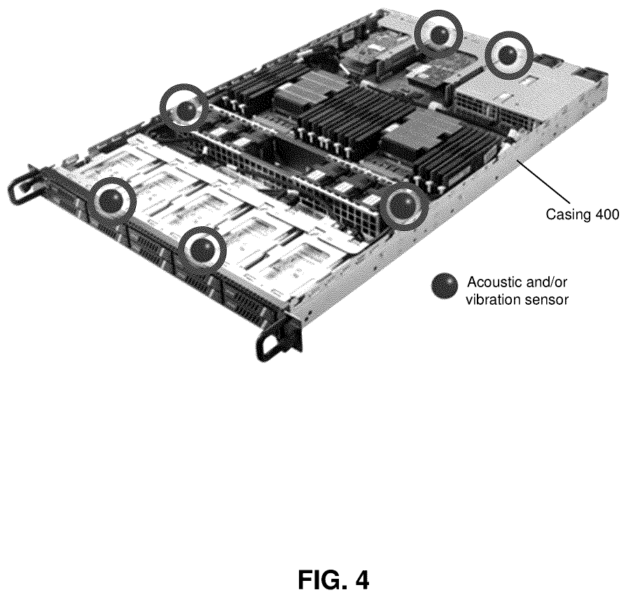

FIG. 4 depicts an example of placements of acoustic and/or vibration sensors. For example, acoustic and/or vibration sensors can be placed at various locations around the perimeter of casing 400. Acoustic and/or vibration sensors can collect acoustic spatial data. In some examples, an acoustic and/or vibration sensor may or may not utilize an audio buffering channel, as the acoustic and/or vibration sensors can provide instantaneous pressure measurements that can be averaged with previous values to provide an amplitude estimation. An acoustic and/or vibration sensor can be placed proximate to a thermal manager device to measure the acoustic emissions and vibration from the thermal manager device. By integrating acoustic and/or vibration components within the computer system casing 400, acoustic and/or vibration components can be positioned in isolated areas which have less exposure to the environment noise.

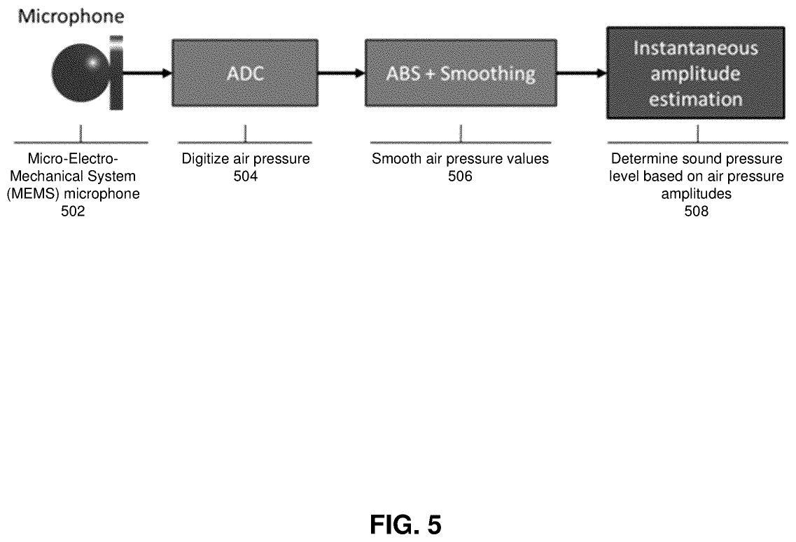

FIG. 5 depicts an example of audio capture. At 502, a microphone (e.g., Micro-Electro-Mechanical System (MEMS) microphone) can capture audio data in a server. At 504, the instantaneous air pressure data can be digitized. At 506, the air pressure values can be averaged to determine a moving average of air pressure values. At 508, the moving average air pressure value can be used as an sound pressure level. A microphone can output an instantaneous pressure level and identifying anomalous sound data based on instantaneous pressure level can produce false positives. Use of a moving average (e.g., absolute value or square of levels) over time can smooth acoustic wave form data and potentially reduce false positive identification of anomaly acoustic signals.

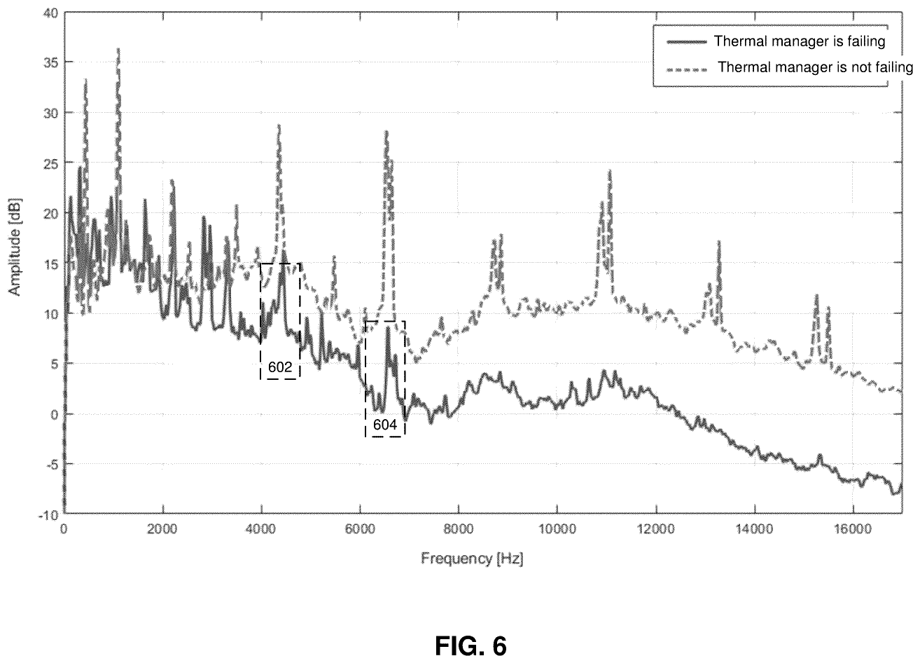

FIG. 6 depicts an example of spectrum of recorded audio signals. Spectral characteristics of sound can change dramatically if the server fans stop working correctly. For example, sound characteristics 602 and 604 can indicate thermal manager malfunction.

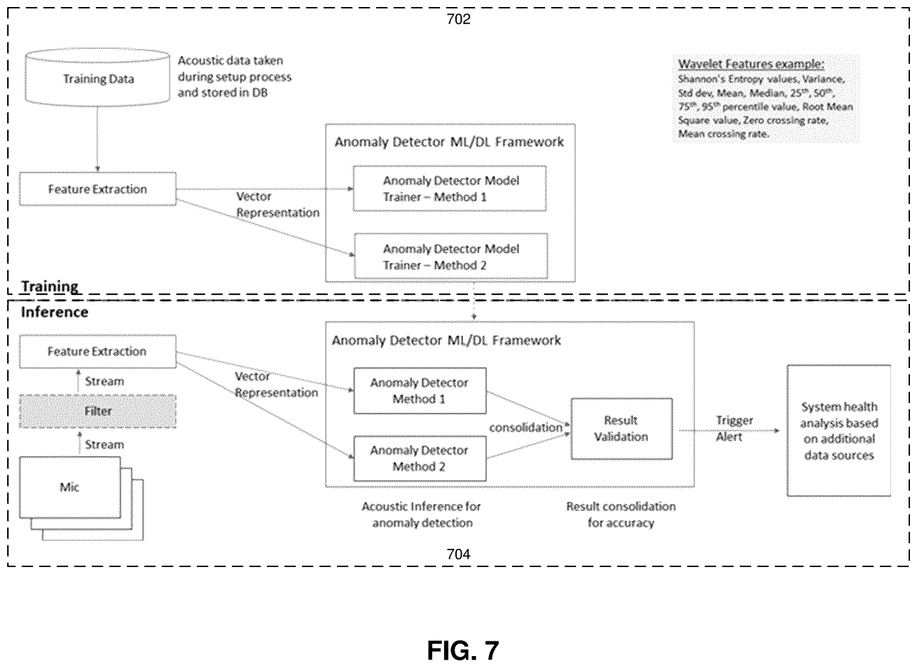

FIG. 7 depicts an example of training and inference stages of defective device detection using multiple ML models. In 702, a training is performed. During setup process, acoustic and/or vibration data can be captured (e.g., periodically or depending on training configuration). Circuitry (e.g., management process 124) can process the acoustic and/or vibration data and produce a vector representation based on features (e.g., 5 second sample converted to vector representation). Vector representation features representing wavelets may include Shannon's entropy values, variance, standard deviation, mean, median, 25th, 50th, 75th, 95th percentile values, Root Mean Square (RMS) value, zero crossing rate, mean crossing rate, or others. With this set of values representing a sample, management process can train multiple AI models. In this case, N models are generated using different techniques, where N is an integer and a value of N depends on accuracy and reliability.

For example, one of the N models can be based on “LOF: Identifying Density-Based Local Outliers,” Breunig, M. M., Kriegel, H. P., Ng, R. T., & Sander, J. (2000 May). LOF provides an unsupervised anomaly detection model which computes local density deviation of given data points vs its neighbors for identifying outliers. For example, one of the N models can be based on an unsupervised learning model (e.g., autoencoder). Autoencoder can learn a representation (encoding) for a set of data, for dimensionality reduction, by training the network to ignore signal noise. Along with the reduction side, a reconstructing side is learned, where the autoencoder tries to generate, from the reduced encoding, a representation as close as possible to its original input. Autoencoder can calculate the Mean Square Error (MSE) between the input and the output, and then define a threshold value. If the MSE is higher than the threshold value, then an anomaly is identified.

In 704, inference operations can occur. One or more microphones can capture acoustic data, that can be optionally filtered by an acoustic pre-processor (e.g., digital signal processor (DSP)). Moreover, one or more vibration sensors can capture vibration data. Circuitry (e.g., management process 124) can process acoustic and/or vibration data by slicing the acoustic and/or vibration data into chunks and generating a vector representation of acoustic and/or vibration data for analysis using N different AI models. If the N or more AI models provide the same result of indicating detected anomaly, an alert can be triggered. Use of N or more AI models can reduce a number of false positives. For example, additional processing, described herein, can be performed based on anomaly detection such as temperature data, vibration data, fan status (e.g., on or off), or others.

For a fleet of servers, ambient noise and/or vibration data can be confirmed or isolated, by orchestrating the behavior of a fleet. For example, based on detection of an anomaly sound and/or vibration data, the orchestrator may perform actions such as changing a power plan or reduce the processing of certain workload, for a period of time, while attempting to identify a problematic server or component.

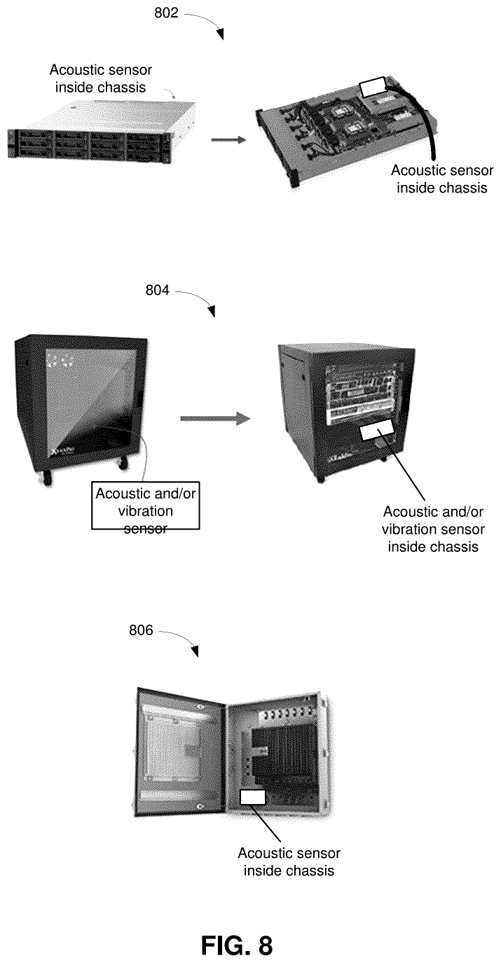

FIG. 8 depicts an example of noise controlled environments. Environment 802 can include a rack server with acoustic and/or vibration data anomaly detection integrated in a management controller. Environment 804 can include rackmount cabinet or rack enclosure with an acoustic sensor inside the chases. Environment 806 can include rugged enclosure, such as for an Internet of Things (IoT) deployment.

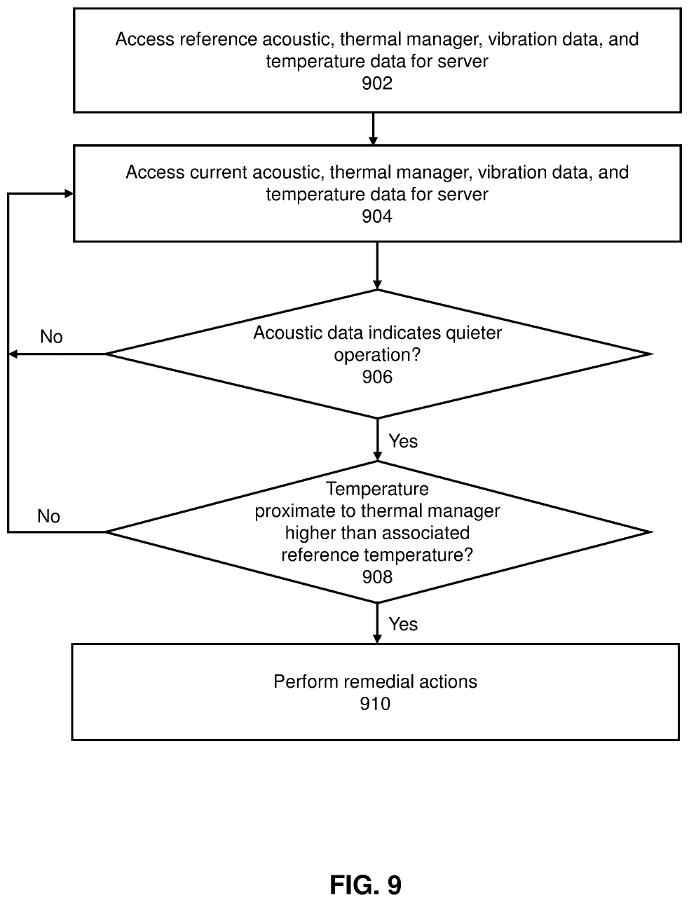

FIG. 9 depicts an example process. The process can be performed by a processor-executed software, firmware, and/or circuitry in a server. At 902, reference acoustic, thermal manager device, vibration data, and/or temperature data can be accessed. For example, at startup of the server or periodically thereafter, spatial audio data and/or vibration data can be measured and stored in memory. For example, at startup of the server or periodically thereafter, data of thermal manager device (e.g., fan or impeller operating points (e.g., RPM)) can be measured and stored in memory. In some examples, stored spatial locations of thermal manager devices are accessed. For example, at startup of a server or periodically thereafter, the reference temperatures and/or vibration data can be measured and stored for the devices (e.g., CPUs, GPUs, memory, accelerators, or others) can be accessed from memory.

At 904, current acoustic, thermal manager device, vibration data, and/or temperature data can be accessed. For example, current spatial acoustic data can be accessed from thermal manager devices in the server. In addition, thermal manager device operating parameters can be accessed (e.g., RPM). Temperature data of the devices can be accessed. Vibration data of devices can be accessed.

At 906, a determination can be made of whether acoustic data indicates quieter operation of a thermal manager device. Based on a determination that the thermal manager device is operating more quietly or within a configured percentage of difference (e.g., dB) from a reference acoustic data for the thermal manager device, the process can return to 904. Based on a determination that the thermal manager device is operating more loudly or configured percentage of difference from the reference acoustic data for the thermal manager device, the process can proceed to 908.

At 908, a determination can be made as to whether the thermal manager device that is operating at a quieter acoustic level is associated with a lower temperature device. For example, where a current temperature is lower than a reference temperature, then fan speed has dropped because an associated device is to be cooled at a lower level, resulting in lower acoustic signal levels. Based on a quieter acoustic level associated with a lower temperature device, the process can end or return to 904. Based on a quieter acoustic level associated with a device that is higher temperature than a reference temperature for the device, a malfunctioning thermal manager device can be identified, and the process can proceed to 910. For example, one or multiple AI or ML models can be used, as described herein, to identify an anomaly acoustic signal or detect a defective device or defective thermal manager device.

Note that in some examples, device activity log data can also be accessed to identify whether an acoustic anomaly is associated with an activity in the device and the acoustic anomaly is not to be considered to be associated with a malfunctioning device. In some examples, vibration data can be measured and utilized to determine whether a fan is malfunctioning if vibrations levels are above a configured level.

At 910, the process can perform remedial actions based on a detected malfunctioning thermal manager device. For example, the process can lower the power to the device or shut off the device to prevent thermal runaway of the device or catastrophic failure. For example, the process can contact a maintenance engineer by electronic mail or phone messaging and identify the thermal manager device that was identified as potentially malfunctioning with failed device ID and chassis grid location.

FIG. 10 depicts a system. In some examples, circuitry of system 1000 can be configured to identify a defective device based on sound analysis during operation of system 100, as described herein. System 1000 includes processor 1010, which provides processing, operation management, and execution of instructions for system 1000. Processor 1010 can include any type of microprocessor, central processing unit (CPU), graphics processing unit (GPU), XPU, processing core, or other processing hardware to provide processing for system 1000, or a combination of processors. An XPU can include one or more of: a CPU, a graphics processing unit (GPU), general purpose GPU (GPGPU), and/or other processing units (e.g., accelerators or programmable or fixed function FPGAs). Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a programmable or fixed function offload engine that can be accessed or used by a processor 1010. For example, an accelerator among accelerators 1042 can provide data compression (DC) capability, cryptography services such as public key encryption (PKE), cipher, hash/authentication capabilities, decryption, matrix arithmetic or multiplication, or other capabilities or services. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

Applications 1034 and/or processes 1036 can refer instead or additionally to a virtual machine (VM), container, microservice, processor, or other software.

In some examples, OS 1032 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 1032, a system administrator, and/or orchestrator can configure circuitry to identify a defective device based on sound analysis during operation of system 100, as described herein.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. In some examples, packet processing device or network interface device 1050 can refer to one or more of: a network interface controller (NIC), a remote direct memory access (RDMA)-enabled NIC, SmartNIC, SuperNIC with an accelerator, router, switch, forwarding element, infrastructure processing unit (IPU), edge processing unit (EPU), or data processing unit (DPU). An EPU can include a network interface device that utilizes processors and accelerators (e.g., digital signal processors (DSPs), signal processors, or wireless specific accelerators for Virtualized Radio Access Networks (vRANs), cryptographic operations, compression/decompression, and so forth).

In some examples, operations of management controller 1044 can identify a defective device based on sound analysis during operation of system 100, as described herein.

In one example, system 1000 includes one or more input/output (I/O) interface(s) 1060. I/O interface 1060 can include one or more interface components through which a user interacts with system 1000. Peripheral interface 1070 can include any hardware interface not specifically mentioned above. Peripherals refer generally to devices that connect dependently to system 1000.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 stores code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 1000 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1000 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: circuitry to receive data associated with a device and determine whether the device is potentially malfunctioning based on anomalous sounds in an operational server and based on an activity indicator of the server, wherein the device comprises one or more of: a processor, a memory device, a thermal manager device, or a circuit board.

Example 2 includes one or more examples, wherein the data comprises a temperature signal and a sound signal and wherein the circuitry is to: based on a first level of the temperature signal and a first characteristic of the sound signal, determine that the device of the server is potentially malfunctioning; and based on a second level of the temperature signal and a second characteristic of the sound signal, determine that the device of the server is not potentially malfunctioning.

Example 3 includes one or more examples, wherein the first level of the temperature signal is to indicate that a temperature of the device is above a reference temperature level and the second level of the temperature signal is to indicate that the temperature of the device is approximately equal to or less than the reference temperature level.

Example 4 includes one or more examples, wherein the circuitry is to access event log data indicative of the activity indicator of the server and determine that an anomalous sound of the anomalous sounds is not predictive of potential device malfunction based on the accessed event log data.

Example 5 includes one or more examples, wherein the circuitry is to access event log data indicative of the activity indicator of the server and the circuitry is to predict failure of the device based on a sound signal and the event log data.

Example 6 includes one or more examples, wherein based on the determination that the device is potentially malfunctioning, the circuitry is to indicate predicted failure of the device and reduce power supplied to the device.

Example 7 includes one or more examples, wherein based on the determination that the device is potentially malfunctioning, the circuitry is to output a location of the device.

Example 8 includes one or more examples, wherein the circuitry is to apply a machine learning (ML) model to determine whether the device is potentially malfunctioning based on the anomalous sounds in the operational server.

Example 9 includes one or more examples, wherein the circuitry is to apply multiple machine learning (ML) models to identify the anomalous sound in the operational server.

Example 10 includes one or more examples, and includes a method comprising: determining whether a non-mechanical aspect of a device in an operational server is potentially malfunctioning by applying a trained machine learning (ML) model to identify anomalous sounds, wherein the device comprises one or more of: a processor, a memory device, a thermal manager device, or a circuit board and providing an indication of potential malfunction of the device based on determining that the device is potentially malfunctioning.

Example 11 includes one or more examples, wherein the determining whether the non-mechanical aspect of the device is potentially malfunctioning comprises: based on a first level of a temperature signal and a first characteristic of a sound signal, determining that the device of the server is malfunctioning and based on a second level of the temperature signal and a second characteristic of the sound signal, determining that the device of the server is not malfunctioning.

Example 12 includes one or more examples, wherein the device comprises the thermal manager device and wherein the first characteristic of the sound signal is to indicate operation of the thermal manager device is below a reference level of operation, the first level of the temperature signal is to indicate that a temperature of the device is above a reference temperature level, the second characteristic of the sound signal is to indicate operation of the thermal manager device is approximately the reference level of operation, and the second level of the temperature signal is to indicate that the temperature of the device is approximately equal to or less than the reference temperature level.

Example 13 includes one or more examples, wherein the determining whether the non-mechanical aspect of the device is potentially malfunctioning comprises: accessing event log data indicative of operation of the device and determining the device is malfunctioning based on a sound signal and the event log data.

Example 14 includes one or more examples, and includes based on the determining the non-mechanical aspect of the device is potentially malfunctioning, reducing power supplied to the device and outputting a location of the device.

Example 15 includes one or more examples, wherein the determining whether the non-mechanical aspect of the device is potentially malfunctioning by applying a trained ML model comprises applying multiple ML models and determining that the non-mechanical aspect of the device is potentially malfunctioning based on agreement of the multiple applied ML models.

Example 16 includes one or more examples, and includes at least one non-transitory computer-readable medium comprising instructions stored thereon, that if executed by one or more processors, cause the one or more processors to: determine whether a device in an operational server is potentially malfunctioning by applying a trained machine learning (ML) model and based on anomalous sounds and activity level of the server, wherein the device comprises one or more of: a processor, a memory device, a thermal manager device, or a circuit board.

Example 17 includes one or more examples, wherein the determine whether the device is potentially malfunctioning comprises: based on a first level of a temperature signal and a first characteristic of a sound signal, determining that the device of the server is potentially malfunctioning and based on a second level of the temperature signal and a second characteristic of the sound signal, determining that the device of the server is not malfunctioning.

Example 18 includes one or more examples, wherein the device comprises the thermal manager device and wherein the first characteristic of the sound signal is to indicate operation of the thermal manager device is below a reference level of operation and the second characteristic of the sound signal is to indicate operation of the thermal manager device is approximately the reference level of operation.

Example 19 includes one or more examples, wherein the determine whether the device is potentially malfunctioning comprises: access event log data indicative of the activity level of the server and determine that the device is potentially malfunctioning based on a sound signal and the event log data.

Example 20 includes one or more examples, comprising instructions stored thereon, that if executed by one or more processors, cause the one or more processors to: based on determining the device is potentially malfunctioning, reduce power supplied to the device and outputting a location of the device.

1. An apparatus comprising:
circuitry to receive data associated with a device and
determine whether the device is potentially malfunctioning based on anomalous sounds in an operational server and based on an activity indicator of the server, wherein the device comprises one or more of: a processor, a memory device, a thermal manager device, or a circuit board.

2. The apparatus of claim 1, wherein the data comprises a temperature signal and a sound signal and wherein the circuitry is to:
based on a first level of the temperature signal and a first characteristic of the sound signal, determine that the device of the server is potentially malfunctioning; and
based on a second level of the temperature signal and a second characteristic of the sound signal, determine that the device of the server is not potentially malfunctioning.

3. The apparatus of claim 2, wherein
the first level of the temperature signal is to indicate that a temperature of the device is above a reference temperature level and
the second level of the temperature signal is to indicate that the temperature of the device is approximately equal to or less than the reference temperature level.

4. The apparatus of claim 1, wherein the circuitry is to access event log data indicative of the activity indicator of the server and determine that an anomalous sound of the anomalous sounds is not predictive of potential device malfunction based on the accessed event log data.

5. The apparatus of claim 1, wherein the circuitry is to access event log data indicative of the activity indicator of the server and the circuitry is to predict failure of the device based on a sound signal and the event log data.

6. The apparatus of claim 1, wherein based on the determination that the device is potentially malfunctioning, the circuitry is to indicate predicted failure of the device and reduce power supplied to the device.

7. The apparatus of claim 1, wherein based on the determination that the device is potentially malfunctioning, the circuitry is to output a location of the device.

8. The apparatus of claim 1, wherein the circuitry is to apply a machine learning (ML) model to determine whether the device is potentially malfunctioning based on the anomalous sounds in the operational server.

9. The apparatus of claim 1, wherein the circuitry is to apply multiple machine learning (ML) models to identify the anomalous sound in the operational server.

10. A method comprising:
determining whether a non-mechanical aspect of a device in an operational server is potentially malfunctioning by applying a trained machine learning (ML) model to identify anomalous sounds, wherein the device comprises one or more of: a processor, a memory device, a thermal manager device, or a circuit board and
providing an indication of potential malfunction of the device based on determining that the device is potentially malfunctioning.

11. The method of claim 10, wherein the determining whether the non-mechanical aspect of the device is potentially malfunctioning comprises:
based on a first level of a temperature signal and a first characteristic of a sound signal, determining that the device of the server is malfunctioning and
based on a second level of the temperature signal and a second characteristic of the sound signal, determining that the device of the server is not malfunctioning.

12. The method of claim 11, wherein the device comprises the thermal manager device and wherein
the first characteristic of the sound signal is to indicate operation of the thermal manager device is below a reference level of operation,
the first level of the temperature signal is to indicate that a temperature of the device is above a reference temperature level,
the second characteristic of the sound signal is to indicate operation of the thermal manager device is approximately the reference level of operation, and
the second level of the temperature signal is to indicate that the temperature of the device is approximately equal to or less than the reference temperature level.

13. The method of claim 10, wherein the determining whether the non-mechanical aspect of the device is potentially malfunctioning comprises:
accessing event log data indicative of operation of the device and
determining the device is malfunctioning based on a sound signal and the event log data.

14. The method of claim 10, comprising:
based on the determining the non-mechanical aspect of the device is potentially malfunctioning, reducing power supplied to the device and outputting a location of the device.

15. The method of claim 10, wherein the determining whether the non-mechanical aspect of the device is potentially malfunctioning by applying a trained ML model comprises applying multiple ML models and determining that the non-mechanical aspect of the device is potentially malfunctioning based on agreement of the multiple applied ML models.

16. At least one non-transitory computer-readable medium comprising instructions stored thereon, that if executed by one or more processors, cause the one or more processors to:
determine whether a device in an operational server is potentially malfunctioning by applying a trained machine learning (ML) model and based on anomalous sounds and activity level of the server, wherein the device comprises one or more of: a processor, a memory device, a thermal manager device, or a circuit board.

17. The at least one non-transitory computer-readable medium of claim 16, wherein the determine whether the device is potentially malfunctioning comprises:
based on a first level of a temperature signal and a first characteristic of a sound signal, determining that the device of the server is potentially malfunctioning and
based on a second level of the temperature signal and a second characteristic of the sound signal, determining that the device of the server is not malfunctioning.

18. The at least one non-transitory computer-readable medium of claim 17, wherein the device comprises the thermal manager device and wherein
the first characteristic of the sound signal is to indicate operation of the thermal manager device is below a reference level of operation and
the second characteristic of the sound signal is to indicate operation of the thermal manager device is approximately the reference level of operation.

19. The at least one non-transitory computer-readable medium of claim 16, wherein the determine whether the device is potentially malfunctioning comprises:
access event log data indicative of the activity level of the server and
determine that the device is potentially malfunctioning based on a sound signal and the event log data.

20. The at least one non-transitory computer-readable medium of claim 16, comprising instructions stored thereon, that if executed by one or more processors, cause the one or more processors to:
based on determining the device is potentially malfunctioning, reduce power supplied to the device and outputting a location of the device.
